(19) United States
(12) Patent Application Publication
(10) Pub. No.: US 2019/0039626 A1
(43) Pub. Date: Feb. 7, 2019

(54) VEHICLE CONTROL DEVICE, VEHICLE CONTROL METHOD, AND VEHICLE CONTROL PROGRAM

(71) Applicant: HONDA MOTOR CO., LTD., Minato-ku, Tokyo (JP)

(72) Inventor: Kunimichi Hatano, Wako-shi (JP)

(73) Assignee: HONDA MOTOR CO., LTD., Minato-ku, Tokyo (JP)

(21) Appl. No.: 16/076,332

(22) PCT Filed: Feb. 18, 2016
(86) PCT No.: PCT/JP2016/054679

§ 371 Date: Aug. 8, 2018

(51) Int. Cl. B60W 50/12; G05D 1/00; B60W 50/10

(52) U.S. Cl. CPC B60W 50/12; G05D 1/0088; G05D 2201/0213; B60W 50/10; G05D 1/0061

(57) ABSTRACT

A vehicle control device includes an automated driving control unit that automatically controls at least a steering of a subject vehicle so that the subject vehicle travels along a route to a destination, and a switching controller that switches a driving mode of the subject vehicle among a plurality of driving modes including a first driving mode and a second driving mode in which a degree of automated driving is lower than that in the first driving mode on the basis of an operation performed with respect to an operation device on which an operation of a vehicle occupant is performed, the switching controller prohibiting switching from the first driving mode to the second driving mode based on an operation for instructing acceleration of the subject vehicle with respect to the operation device when control to automatically perform lane change is performed by the automated driving control unit.

### BACKGROUND

### Field of the Invention

The present invention relates to a vehicle control device, a vehicle control method, and a vehicle control program.

### Description of Related Art

In recent years, research on technology for automatically controlling at least one of acceleration or deceleration and steering of a subject vehicle so that the subject vehicle travels along a route to a destination (hereinafter referred to as automated driving) has been performed. In relation thereto, a technology for executing automatic steering control of a subject vehicle according to a subject vehicle position, a subject vehicle traveling route, and a target traveling route, and stopping the travel control of the subject vehicle when a differential value of a distance of the subject vehicle traveling route from the target traveling route in front increases and a steering torque of the subject vehicle exceeds a preset value has been disclosed (see, for example, Japanese Unexamined Patent Application, First Publication No. 2005-067322).

### SUMMARY

In recent years, in a technology of automated driving being studied, a situation in which a driving mode is switched from fully automated driving to semiautomated driving or manual driving, or from semi-automated driving to manual driving on the basis of an external environment and an intention of a vehicle occupant is assumed. However, in the related art, there is a case in which continuity of control cannot be maintained by switching the driving mode.

The present invention has been made in consideration of such circumstances, and an object of one embodiment of the present invention is to provide a vehicle control device, a vehicle control method, and a vehicle control program capable of maintaining continuity of control.

An invention according to Claim 1 is an automated driving control device (100) including: an automated driving control unit (110) that automatically controls at least a steering of a subject vehicle so that the subject vehicle travels along a route to a destination; and a switching controller (140) that switches a driving mode of the subject vehicle among a plurality of driving modes including a first driving mode and a second driving mode in which a degree of automated driving is lower than that in the first driving mode on the basis of an operation performed with respect to an operation device on which an operation of a vehicle occupant is performed, the switching controller prohibiting switching from the first driving mode to the second driving mode based on an operation for instructing acceleration of the subject vehicle with respect to the operation device when control to automatically perform lane change is performed by the automated driving control unit.

As an invention according to Claim 2, in the invention according to Claim 1, the first driving mode is a driving mode in which both acceleration or deceleration and a steering of the subject vehicle are automatically controlled, and the second driving mode is a driving mode in which the steering of the subject vehicle is automatically controlled and the acceleration or deceleration is controlled on the basis of an operation with respect to the operation device.

As an invention according to Claim 3, in the invention according to Claim 1, the first driving mode is a driving mode in which both acceleration or deceleration and a steering of the subject vehicle are automatically controlled, and the second driving mode is a driving mode in which both the acceleration or deceleration and the steering of the subject vehicle are controlled on the basis of an operation of the vehicle occupant with respect to the operation device.

As an invention according to Claim 4, in the invention according to any one of Claim 1 to Claim 3, when control to automatically perform lane change is not performed by the automated driving control unit, the switching controller switches the driving mode of the subject vehicle from the first driving mode to the second driving mode on the basis of an operation for instructing acceleration of the subject vehicle with respect to the operation device.

As an invention according to Claim 5, in the invention according to any one of Claim 1 to Claim 4, when the automated driving control unit performs control to automatically perform the lane change, the switching controller does not prohibit switching from the first driving mode to the second driving mode based on an operation for instructing deceleration of the subject vehicle with respect to the operation device.

An invention according to Claim 6 is a vehicle control method including: automatically controlling, by an in-vehicle computer, at least a steering of a subject vehicle so that the subject vehicle travels along a route to a destination; and switching, by the in-vehicle computer, a driving mode of the subject vehicle among a plurality of driving modes including a first driving mode and a second driving mode in which a degree of automated driving is lower than that in the first driving mode on the basis of an operation performed with respect to an operation device on which an operation of a vehicle occupant is performed, and prohibiting switching from the first driving mode to the second driving mode based on an operation for instructing acceleration of the subject vehicle with respect to the operation device when control to automatically perform lane change is performed by automatically controlling at least the steering of the subject vehicle.

An invention according to Claim 7 is a vehicle control program causing an in-vehicle computer to: automatically control at least a steering of a subject vehicle so that the subject vehicle travels along a route to a destination; switch a driving mode of the subject vehicle among a plurality of driving modes including a first driving mode and a second driving mode in which a degree of automated driving is lower than that in the first driving mode on the basis of an operation performed with respect to an operation device on which an operation of a vehicle occupant is performed; and prohibit switching from the first driving mode to the second driving mode based on an operation for instructing acceleration of the subject vehicle with respect to the operation device when control to automatically perform lane change is performed by automatically controlling at least the steering of the subject vehicle.

According to the invention described in each Claim, it is possible to maintain continuity of control.

### BRIEF DESCRIPTION OF THE DRAWINGS

FIG. 1 is a diagram illustrating components of a subject vehicle M.

FIG. 2 is a functional configuration diagram of the subject vehicle M.

FIG. 3 is a diagram illustrating a state in which a relative position of the subject vehicle M relative to a travel lane L1 is recognized by a subject-vehicle position recognizer.

FIG. 4 is a diagram illustrating an example of an action plan generated for a certain section.

FIG. 5 is a diagram illustrating an example of a trajectory generated by a trajectory generator.

FIG. 6 is a flowchart showing an example of a flow of a process that is executed when a lane change event is executed.

FIG. 7 is a diagram illustrating a state in which a target position TA is set.

FIG. 8 is a diagram illustrating a state in which a trajectory for lane change is generated.

FIG. 9 is a state transition diagram illustrating a change in a state of the switching controller.

FIG. 10 is a diagram illustrating an example of a flow of a process that is executed by a switching controller according to the first embodiment.

FIG. 11 is a diagram illustrating an example of a flow of a process that is executed by a switching controller according to a second embodiment.

### DESCRIPTION OF EMBODIMENTS

Hereinafter, embodiments of a vehicle control device, a vehicle control method, and a vehicle control program according to the present invention will be described with reference to the drawings.

### <Common Configuration>

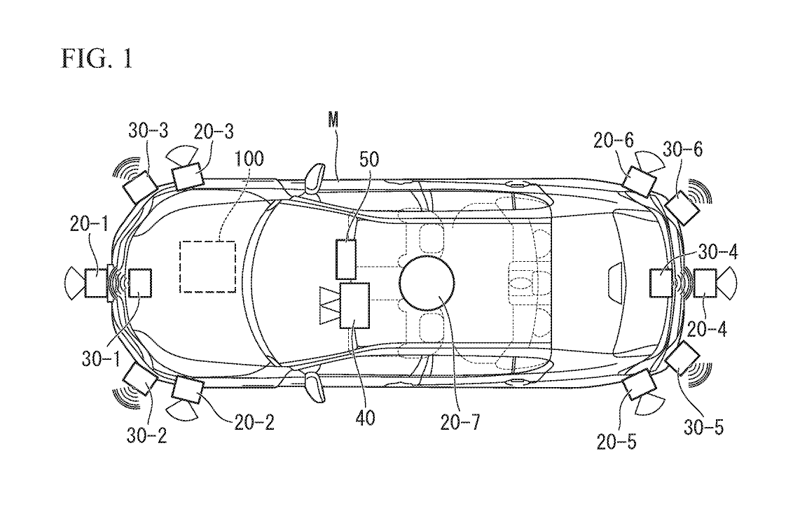

FIG. 1 is a diagram illustrating components included in a vehicle on which a vehicle control device of each embodiment is mounted (hereinafter referred to as a subject vehicle M). The vehicle on which the vehicle control device 100 is mounted is, for example, a two-wheeled car, a three-wheeled car, or a four-wheeled car, and includes a car using an internal combustion engine such as a diesel engine or a gasoline engine as a power source, an electric car using an electric motor as a power source, or a hybrid car with an internal combustion engine and an electric motor. Further, the above-described electric car is driven using electric power that is discharged by a battery such as a secondary battery, a hydrogen fuel cell, a metal fuel cell, or an alcohol fuel cell, for example.

As illustrated in FIG. 1, sensors such as finders 20-1 to 20-7, radars 30-1 to 30-6, and a camera 40, a navigation device 50, and the vehicle control device 100 are mounted on the subject vehicle M. The finders 20-1 to 20-7 are, for example, light detection and ranging or laser imaging detection and ranging (LIDAR) that measures scattered light with respect to irradiation light and measures a distance to a target. For example, the finder 20-1 may be attached to a front grille or the like, and the finders 20-2 and 20-3 may be attached to a side surface of a vehicle body, a door mirror, the inside of a headlight, the vicinity of side lamps, and the like. The finder 20-4 is attached to a trunk lid or the like, and the finders 20-5 and 20-6 are attached to the side surface of the vehicle body, the inside of a taillight, or the like. The finders 20-1 to 20-6 described above have, for example, a detection area of about 150° in a horizontal direction. Further, the finder 20-7 is attached to a roof or the like. The finder 20-7 has, for example, a detection area of 360° in the horizontal direction.

The radars 30-1 and 30-4 described above are, for example, long-distance millimeter-wave radars of which the detection area in a depth direction is wider than those of other radars. Further, the radars 30-2, 30-3, 30-5, and 30-6 are intermediate-distance millimeter wave radars of which the detection area in the depth direction is narrower than those of the radars 30-1 and 30-4. Hereinafter, the finders 20-1 to 20-7 are simply referred to as a “finder 20” when not particularly distinguished, and the radars 30-1 to 30-6 are simply referred to as a “radar 30” when not particularly distinguished. The radar 30 detects an object using, for example, a frequency modulated continuous wave (FM-CW) scheme.

The camera 40 is, for example, a digital camera using a solid-state imaging device such as a charge coupled device (CCD) or a complementary metal oxide semiconductor (CMOS). The camera 40 is attached to an upper portion of a front windshield, a rear surface of a rearview mirror, or the like. The camera 40 periodically and repeatedly images, for example, in front of the subject vehicle M.

It should be noted that the configuration illustrated in FIG. 1 is merely an example, and a part of the configuration may be omitted or other components may be added.

### FIRST EMBODIMENT

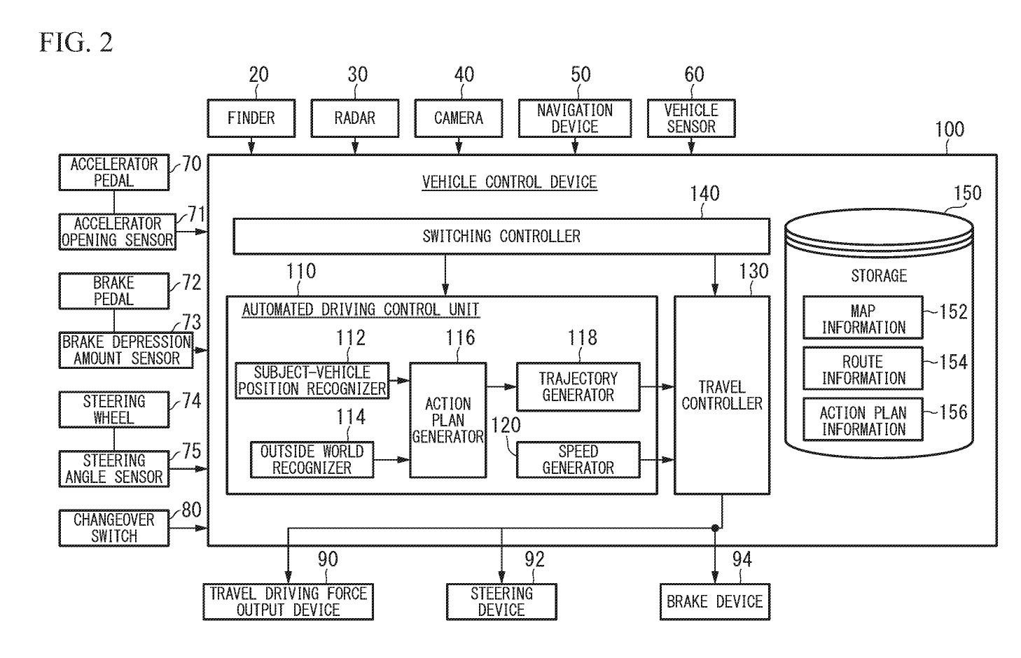

FIG. 2 is a functional configuration diagram of a subject vehicle M on which a vehicle control device 100 is mounted according to a first embodiment. A navigation device 50, a vehicle sensor 60, operation devices such as an accelerator pedal 70, a brake pedal 72, and a steering wheel 74, an operation detection sensor such as an accelerator opening sensor 71, a brake depression amount sensor (brake switch) 73, and a steering angle sensor (or a steering torque sensor) 75, a changeover switch 80, a travel driving force output device 90, a steering device 92, a brake device 94, and a vehicle control device 100 are mounted on the vehicle subject M in addition to the finders 20, the radars 30, and the camera 40. These apparatuses or devices are connected to each other by a multiplex communication line such as a controller area network (CAN) communication line, a serial communication line, or a wireless communication network. It should be noted that the illustrated operation devices are merely examples, and a joystick, a button, a dial switch, a graphical user interface (GUI) switch, and the like may be mounted on the subject vehicle M.

The navigation device 50 includes a global navigation satellite system (GNSS) receiver or map information (navigation map), a touch panel type display device functioning as a user interface, a speaker, a microphone, and the like. The navigation device 50 specifies a position of the subject vehicle M using the GNSS receiver and derives a route from the position to a destination designated by the user. The route derived by the navigation device 50 is stored in a storage 150 as route information 154. The position of the subject vehicle M may be specified or supplemented by an inertial navigation system (INS) using the output of the vehicle sensor 60. Further, when the vehicle control device 100 is executing a manual driving mode, the navigation device 50 performs guidance through speech or a navigation display for the route to the destination. It should be noted that a configuration for specifying the position of the subject vehicle M may be provided independently of the navigation device 50. Further, the navigation device 50 may be realized, for example, by a function of a terminal device such as a smartphone or a tablet terminal possessed by the user. In this case, transmission and reception of information is performed between the terminal device and the vehicle control device 100 through wireless or wired communication.

The vehicle sensors 60 include, for example, a vehicle speed sensor that detects a vehicle speed, an acceleration sensor that detects an acceleration, a yaw rate sensor that detects an angular velocity around a vertical axis, and a direction sensor that detects a direction of the subject vehicle M.

The display unit 62 displays information as an image. The display unit 62 may be, for example, a liquid crystal display (LCD) display device or an organic electroluminescence (EL) display device. In the present embodiment, description will be given on assumption that the display unit 62 is a head-up display that reflects an image on a front window of the subject vehicle M and displays the image in a field of view of the vehicle occupant. It should be noted that the display unit 62 may be a display unit included in the navigation device 50 or a display unit of an instrument panel that displays a state (speed or the like) of the subject vehicle M. The speaker 64 outputs information as sound.

An operation detection sensor outputs the accelerator opening degree, the brake depression amount, and the steering angle as detection results to the vehicle control device 100. It should be noted that, alternatively, the detection results of the operation detection sensor may be output directly to the travel driving force output device 90, the steering device 92, or the brake device 94 according to the driving mode.

The changeover switch 80 is a switch that is operated by the vehicle occupant. The changeover switch 80 receives an operation of the vehicle occupant, generates a driving mode designation signal for designating the driving mode of the subject vehicle M, and outputs the driving mode designation signal to a switching controller 140. The driving mode will be described below.

The travel driving force output device 90, for example, includes an engine and an engine electronic control unit (ECU) that controls the engine in a case in which the subject vehicle M is a car using an internal combustion engine as a power source, includes a traveling motor and a motor ECU that controls the traveling motor in a case in which the subject vehicle M is an electric car using an electric motor as a power source, and includes an engine, an engine ECU, a traveling motor, and a motor ECU in a case in which the subject vehicle M is a hybrid vehicle. In a case in which the travel driving force output device 90 includes only an engine, the engine ECU adjusts a throttle opening degree of the engine, a gear shift stage, and the like according to information input from a travel controller 130 to be described below, and outputs a travel driving force (torque) for causing the subject vehicle to travel. Further, when the travel driving force output device 90 includes only the traveling motor, the motor ECU adjusts a duty ratio of a PWM signal to be given to the traveling motor according to the information input from the travel controller 130, and outputs the above-described travel driving force. Further, when the travel driving force output device 90 includes the engine and the traveling motor, both the engine ECU and the motor ECU cooperate with each other to control the travel driving force according to the information input from the travel controller 130.

The steering device 92 includes, for example, an electric motor. The electric motor, for example, changes a direction of the steerable wheels by applying a force to a rack and pinion mechanism The steering device 92 drives the electric motor such that the direction of the steerable wheels are changed according to the information input from the travel controller 130.

The brake device 94 is, for example, an electric servo brake device including a brake caliper, a cylinder that transfers hydraulic pressure to the brake caliper, an electric motor that generates the hydraulic pressure in the cylinder, and a braking control unit. The brake control unit of the electric servo brake device controls the electric motor according to the information input from the travel controller 130 so that a brake torque according to the braking operation is output to each wheel. The electric servo brake device may include, as a backup, a mechanism for transferring the hydraulic pressure generated by the operation of the brake pedal to the cylinder via a master cylinder. It should be noted that the brake device 94 is not limited to the electric servo brake device described above, and may be an electronically controlled hydraulic brake device. The electronically controlled hydraulic brake device controls an actuator according to the information input from the travel controller 130 and transfers the hydraulic pressure of the master cylinder to the cylinder. In addition, the brake device 94 may include a regenerative brake using a traveling motor that may be included in the travel driving force output device 90.

### [Vehicle Control Device]

Hereinafter, the vehicle control device 100 will be described. The vehicle control device 100 includes, for example, an automated driving control unit 110, the travel controller 130, the switching controller 140, and the storage 150. The automated driving control unit 110 includes, for example, a subject-vehicle position recognizer 112, an outside world recognizer 114, an action plan generator 116, a trajectory generator 118, and a speed generator 120. Some or all of each unit of the automated driving control unit 110, the travel controller 130, and the switching controller 140 may be realized by a processor such as a central processing unit (CPU) executing a program. Further, some or all of these may be realized by hardware such as a large scale integration (LSI) or an application specific integrated circuit (ASIC). Further, the storage 150 is realized by a read only memory (ROM), a random access memory (RAM), a hard disk drive (HDD), a flash memory, or the like. The program to be executed by the processor may be stored in the storage 150 in advance or may be downloaded from an external device via an in-vehicle Internet facility or the like. Further, the program may be installed in the storage 150 by a portable storage medium having the program stored therein being mounted on a drive device (not illustrated). Further, the vehicle control device 100 may be distributed by a plurality of computer devices.

For example, the automated driving control unit 110 is switched among driving mode A, driving mode B, driving mode C, and driving mode D according to an instruction from the switching controller 140 and performs control. Operation mode A is a driving mode in which acceleration, deceleration, and steering of the subject vehicle M are automatically controlled. The driving mode B is a driving mode in which steering of the subject vehicle M is automatically controlled and the acceleration or the deceleration is controlled on the basis of an operation with respect to an operation device such as the accelerator pedal 70 or the brake pedal 72. The driving mode C is a driving mode in which the acceleration or the deceleration of the subject vehicle M is automatically controlled and the steering is controlled on the basis of an operation with respect to an operation device such as the steering wheel 74. The driving mode D is a driving mode in which the acceleration or the deceleration of the subject vehicle M is controlled on the basis of an operation with respect to an operation device such as the accelerator pedal 70 or the brake pedal 72 and the steering is controlled on the basis of an operation with respect to an operation device such as the steering wheel 74 (a manual driving mode). With driving mode D is performed, the automated driving control unit 110 may stop an operation so that an input signal from the operation detection sensor is supplied to the travel controller 130 or so that an input signal from the operation detection sensor is directly supplied to the travel driving force output device 90, the steering device 92, or the brake device 94.

The degree of automated driving is highest in driving mode A and lowest in driving mode D. The degree of automated driving in driving mode B and driving mode C is between that in driving mode A and driving mode D.

The subject vehicle position recognizer 112 of the automated driving control unit 110 recognizes a lane (travel lane) on which the subject vehicle M is traveling, and a relative position of the subject vehicle M with respect to the travel lane on the basis of map information 152 stored in the storage 150, and information input from the finders 20, the radars 30, the camera 40, the navigation device 50, or the vehicle sensor 60. The map information 152 is, for example, map information with higher accuracy than that of the navigation map included in the navigation device 50, and includes, for example, information on a center of a lane or information on boundaries of a lane. More specifically, the map information 152 includes road information, traffic regulations information, address information (address and postal code), facilities information, telephone number information, and the like. The road information includes information indicating types of road such as expressways, toll roads, national highways, and prefectural roads, or information such as the number of lanes on a road, a width of respective lanes, a gradient of a road, a position of a road (three-dimensional coordinates including a longitude, a latitude, and a height), a curvature of a curve of the lane, a position of a merging or branching point of the lane, and a sign provided on a road. The traffic regulation information includes information such as lane closures due to roadwork, traffic accidents, traffic congestion, or the like.

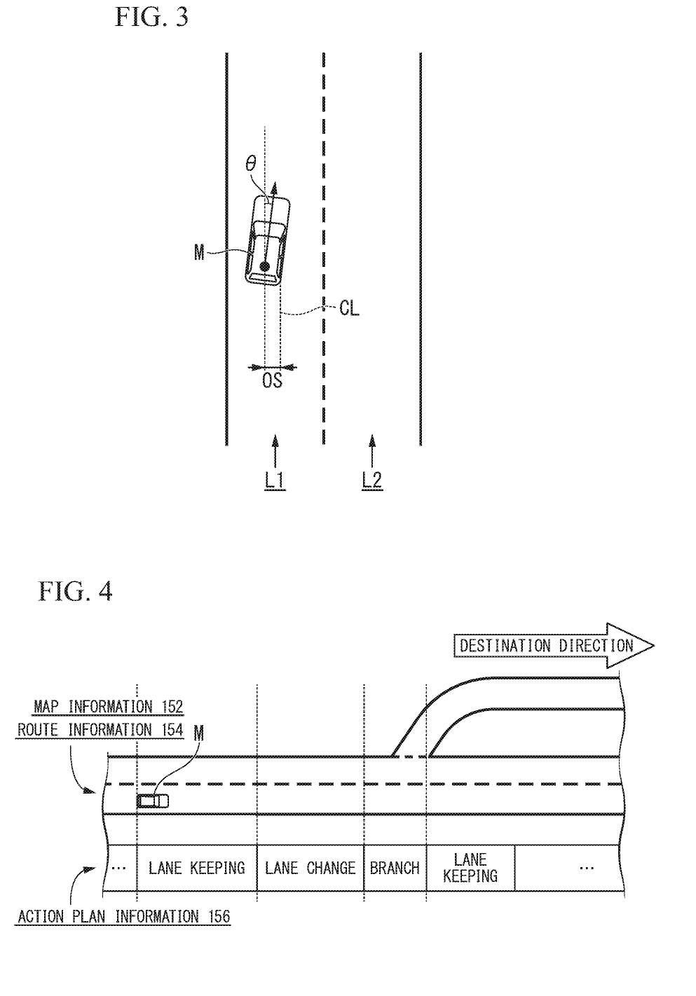

FIG. 3 is a diagram illustrating a state in which the relative position of the subject vehicle M with respect to the travel lane L1 is recognized by the subject-vehicle position recognizer 112. The subject-vehicle position recognizer 112, for example, may recognize a deviation OS of a reference point (for example, a centroid) of the subject vehicle M from a travel lane center CL, and an angle θ with respect to a connecting line along the travel lane center CL in the travel direction of the subject vehicle M, as the relative position of the subject vehicle M with respect to the travel lane L1. It should be noted that, instead of this, the subject-vehicle position recognizer 112 may recognize, for example, the position of the reference point of the subject vehicle M with respect to one of side portions of the subject lane L1 as the relative position of the subject vehicle M with respect to the travel lane.

The outside world recognizer 114 recognizes a state such as a position, a speed, and an acceleration of a nearby vehicle on the basis of information input from the finder 20, the radar 30, the camera 40, and the like. The nearby vehicle in this embodiment is a vehicle that is traveling nearby the subject vehicle M and is a vehicle that travels in the same direction as that of the subject vehicle M. The position of the nearby vehicle may be represented by a representative point such as a centroid or a corner of another vehicle or may be represented by an area represented by an outline of another vehicle. The “state” of the nearby vehicle may include an acceleration of the nearby vehicle, and an indication of whether or not the nearby vehicle is changing lane (or whether or not the nearby vehicle is about to change lane) on the basis of the information of the various devices described above. Further, the outside world recognizer 114 may also recognize a position of a guardrail, a utility pole, a parked vehicle, a pedestrian, and other objects, in addition to nearby vehicles.

The action plan generator 116 sets a starting point of automated driving and/or a destination for automated driving. The starting point of automated driving may be a current position of the subject vehicle M or may be a point at which an operation for instructing automated driving is performed. The action plan generator 116 generates the action plan in a section between the starting point and the destination of automated driving. It should be noted that the present invention is not limited thereto, and the action plan generator 116 may generate the action plan for any section.

The action plan includes, for example, a plurality of events that are executed sequentially. Examples of the events include a deceleration event for decelerating the subject vehicle M, an acceleration event for accelerating the subject vehicle M, a lane keeping event for causing the subject vehicle M to travel so that the subject vehicle M does not deviate from a travel lane, a lane change event for changing travel lane, an overtaking event for causing the subject vehicle M to overtake a preceding vehicle, a branching event for changing a lane to a desired lane at a branch point or causing the subject vehicle M to travel so that the subject vehicle M does not deviate from a current travel lane, and a merging event for accelerating and decelerating the subject vehicle M at a merging lane for merging into a main lane and changing travel lane. For example, when there is a junction (a branch point) in a toll road (for example, a highway), the vehicle control device 100 may change lane so that the subject vehicle M travels in a direction of a destination or keeps in a lane when a first or second automated driving mode is being performed. Accordingly, when it is determined that there is a junction on a route by referring to the map information 152, the action plan generator 116 sets a lane change event for changing a lane to a desired lane in which the vehicle can proceed in the direction of the destination, between the current position (coordinates) of the subject vehicle M and the position (coordinates) of the junction. It should be noted that information indicating the action plan generated by the action plan generator 116 is stored in the storage 150 as action plan information 156.

FIG. 4 is a diagram illustrating an example of an action plan generated for a certain section. As illustrated in FIG. 4, the action plan generator 116 classifies scenes that are generated when the vehicle travels along a route to the destination, and generates an action plan so that an event suitable for each scene is executed. The action plan generator 116 may dynamically change the action plan according to a change in a situation of the subject vehicle M.

The action plan generator 116, for example, may change (update) the generated action plan on the basis of a state of the outside world recognized by the outside world recognizer 114. Generally, the state of the outside world changes constantly while the vehicle is traveling. In particular, when the subject vehicle M travels on a road including a plurality of lanes, a distance between the subject vehicle M and other vehicles changes relatively. For example, when a vehicle in front decelerates due to sudden braking or a vehicle traveling in a neighboring lane cuts in front of the subject vehicle M, it is necessary for the subject vehicle M to travel while appropriately changing speed or lane according to a behavior of the vehicle in front or a behavior of the vehicle on an adjacent lane. Therefore, the action plan generator 116 may change an event set for each control section according to a change in a state of the outside world as described above.

Specifically, when a speed of the other vehicle recognized by the outside world recognizer 114 exceeds a threshold value during vehicle traveling or a moving direction of the other vehicle traveling in the lane adjacent to the subject lane is directed to a direction of the subject lane, the action plan generator 116 may change an event set in a driving section in which the subject vehicle M is scheduled to travel. For example, in a case in which an event is set so that a lane change event is executed after a lane keeping event, when it has been found from a result of the recognition of the outside world recognizer 114 that a vehicle travels at a speed equal to or higher than a threshold value from behind in a lane that is a lane change destination during the lane keeping event, the action plan generator 116 changes an event subsequent to the lane keeping event from a lane change to a deceleration event, a lane keeping event, or the like. As a result, even when a change occurs in a state of the outside world, the vehicle control device 100 can cause the subject vehicle M to safely automatically travel.

### [Lane Keeping Event]

When a lane keeping event is executed, the action plan generator 116 determines a traveling aspect of any one of constant speed traveling, following traveling, decelerating traveling, curved traveling, obstacle avoidance traveling, and the like. For example, when there are no other vehicles in front of the subject vehicle M, the action plan generator 116 may determine the travel aspect to be constant speed traveling. Further, when the vehicle follows the preceding vehicle, the action plan generator 116 determines the travel aspect to be following traveling. Further, when the outside world recognizer 114 recognizes deceleration of the preceding vehicle or when an event such as stopping or parking is performed, the action plan generator 116 determines the travel aspect to be decelerating traveling. Further, when the outside world recognizer 114 recognizes that the subject vehicle M has arrived at a curved road, the action plan generator 116 determines the travel aspect to be curved traveling. Further, when an obstacle is recognized in front of the subject vehicle M by the outside world recognizer 114, the action plan generator 116 determines the travel aspect to be the obstacle avoidance traveling.

The trajectory generator 118 generates a trajectory on the basis of the travel aspect determined by the action plan generator 116. The trajectory is a set (locus) of points obtained by sampling future target positions assumed to be reached at predetermined time intervals when the subject vehicle M travels on the basis of the travel aspect determined by the action plan generator 116. The trajectory generator 118 calculates the target speed of the subject vehicle M on the basis of at least a speed of a target OB present in front of the subject vehicle M recognized by the subject-vehicle position recognizer 112 or the outside world recognizer 114, and a distance between the subject vehicle O and the target OB. The trajectory generator 118 generates a trajectory on the basis of the calculated target speed. The target OB includes a preceding vehicle, a point such as a merging point, a branch point, or a target point, an object such as an obstacle, and the like.

It should be noted that generation of a plurality of trajectory points including a speed element (a time element) is a case in which driving mode A is performed, and in driving mode B, a locus or a trajectory point including no speed element (time element) is generated and a speed at which the vehicle travels on the locus is controlled on the basis of the operation with respect to the operation device of the vehicle occupant. Further, in driving mode C, no trajectory points or locus is generated, and only the speed is automatically determined by the speed generator 120 on the basis of the traveling aspect such as constant speed traveling, following traveling, and decelerating traveling.

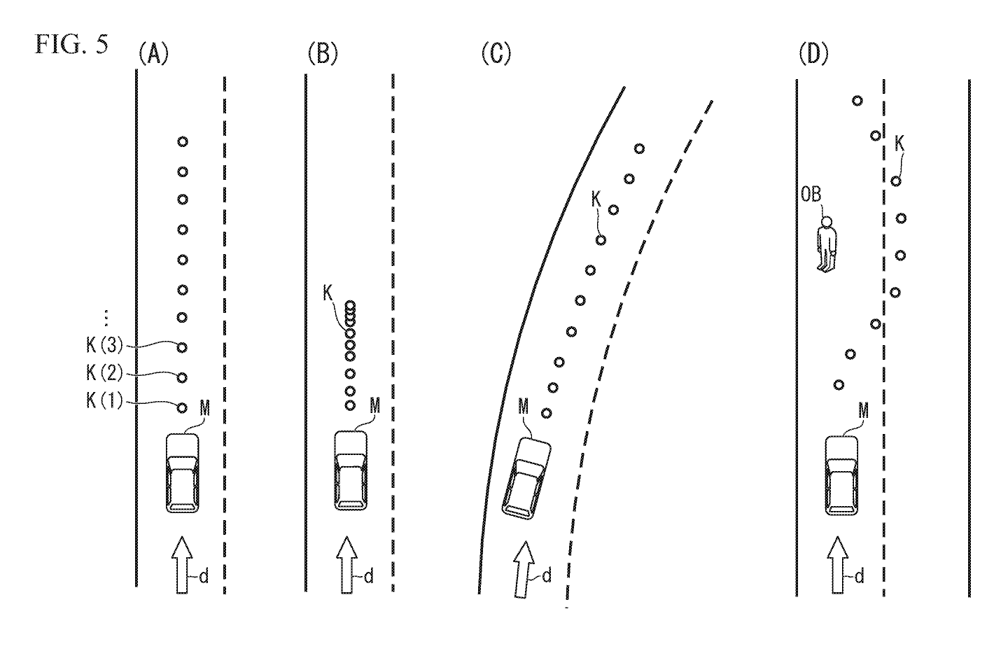

Hereinafter, the generation of the trajectory, particularly, in both a case in which the presence of the target OB is not considered and a case in which the presence of the target OB is considered while focusing on driving mode A will be described. FIG. 5 is a diagram illustrating an example of a trajectory generated by the trajectory generator 118. As illustrated in (A) of FIG. 5, for example, the trajectory generator 118 sets future target positions K(1), K(2), K(3), . . . as the trajectory of the subject vehicle M each time a predetermined time At elapses from a current time on the basis of the current position of the subject vehicle M. Hereinafter, these target positions are simply referred to as a “target position K” when the target positions are not distinguished. For example, the number of target positions K is determined according to a target time T. For example, when the target time T is set to five seconds, the trajectory generator 118 sets the target positions K on a center line of the travel lane in increments of a predetermined time At (for example, 0.1 second) during five seconds, and determines an arrangement interval of the plurality of target positions K on the basis of the travel aspect. For example, the trajectory generator 118 may derive the center line of the travel lane from information such as a width of the lane included in the map information 152 or may acquire the center line from the map information 152 when the position of the center line is included in the map information 152 in advance.

For example, when the travel aspect is determined to be constant speed traveling by the action plan generator 116 described above, the trajectory generator 118 may set a plurality of target positions K at equal intervals to generate a trajectory, as illustrated in (A) of FIG. 5.

Further, when the travel aspect is determined to be deceleration traveling by the action plan generator 116 (including a case in which a preceding vehicle decelerates in the following traveling), the trajectory generator 118 generates a trajectory in which an interval is wider for the target position K of which an arrival time is earlier and is narrower for the target position K of which the arrival time is later, as illustrated in (B) of FIG. 5. In this case, the preceding vehicle may be set as the target OB or a point such as a merging point, a branch point, or a target point, an obstacle, or the like other than the preceding vehicle may be set as the target OB. Accordingly, since the target position K of which the arrival time of the subject vehicle M is later becomes closer to the current position of the subject vehicle M, the travel controller 130 to be described below decelerates the subject vehicle M.

Further, as illustrated in (C) of FIG. 5, when the travel aspect is determined to be curved traveling, the trajectory generator 118, for example, arranges a plurality of target positions K while changing a lateral position with respect to the travel direction of the subject vehicle M (a position in a lane width direction) according to a curvature of the road, to generate a trajectory. Further, as illustrated in (D) of FIG. 5, when there is an obstacle OB such as a person or a stopped vehicle on a road in front of the subject vehicle M, the action plan generator 116 determines the travel aspect to obstacle avoidance traveling. In this case, the trajectory generator 118 arranges the plurality of target positions K so that the vehicle travels while avoiding the obstacle OB, to generate the trajectory.

### [Lane Change Event]

Further, when a lane change event is performed, the trajectory generator 118 performs processes such as setting of a target position, a determination as to whether or not the lane change can be performed, generation of a lane change trajectory, and trajectory evaluation. Further, the trajectory generator 118 may perform the same process even when a branch event or a merging event is executed.

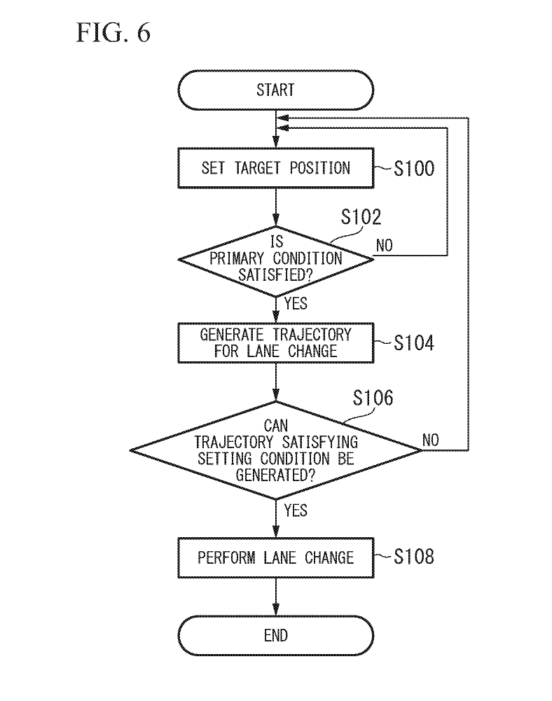

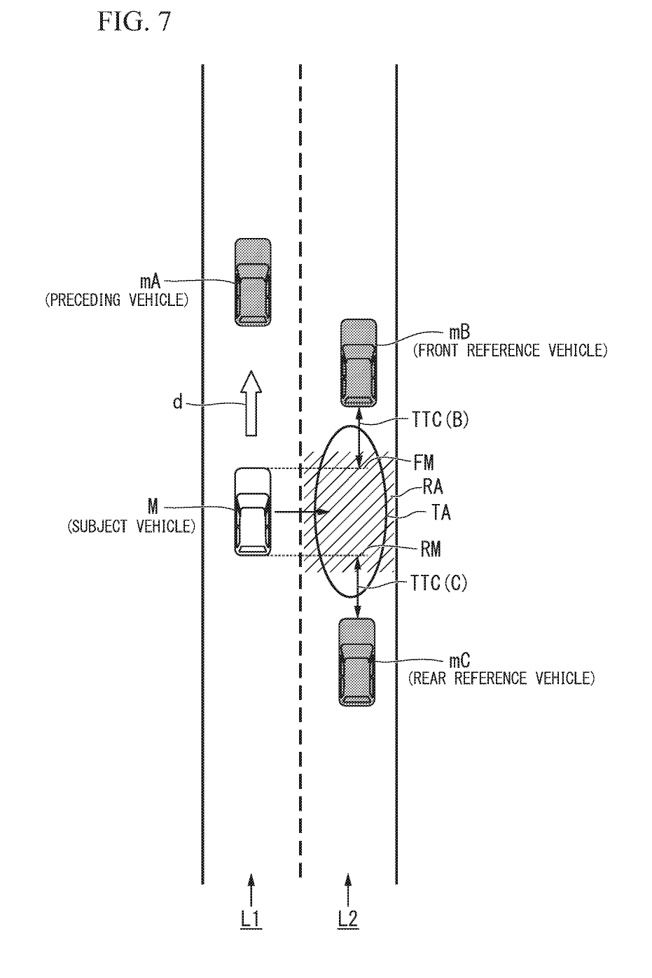

FIG. 6 is a flowchart showing an example of a flow of a process that is executed when the lane change event is executed. The process will be described with reference to this drawing and FIG. 7.

First, the trajectory generator 118 specifies a vehicle that travels on an adjacent lane adjacent to a lane (subject lane) on which the subject vehicle M travels, which is an adjacent lane that is a lane change destination, and travels in front of the subject vehicle M, and a vehicle that travels on the adjacent lane and travels behind the subject vehicle M, and sets the target position TA between these vehicles (step S100). In the following description, the vehicle traveling on the adjacent lane and traveling ahead of the subject vehicle M will be referred to as a front reference vehicle, and the vehicle traveling on the adjacent lane and traveling behind the subject vehicle M will be referred to as a rear reference vehicle. The target position TA is a relative position based on a positional relationship between the subject vehicle M, and the front reference vehicle and the rear reference vehicle.

FIG. 7 is a diagram illustrating a state in which the target position TA is set. In FIG. 7, mA indicates a preceding vehicle, mB indicates a front reference vehicle, and mC indicates a rearward reference vehicle. Further, an arrow d indicates a traveling (traveling) direction of the vehicle M, L1 indicates the subject lane, and L2 indicates the adjacent lane. In the example of FIG. 7, the target position setting unit 122 sets the target position TA between the front reference vehicle mB and the rear reference vehicle mC on the adjacent lane L2.

Then, the trajectory generator 118 determines whether or not a primary condition for determining whether or not a lane change to the target position TA (that is, between the front reference vehicle mB and the rear reference vehicle mC) is possible is satisfied (step S102).

The primary condition is that, for example, there is no nearby vehicle even in a part of prohibition area RA set in the adjacent lane and a TTC of the subject vehicle M and the front reference vehicle mB and the rear reference vehicle mC is greater than a threshold value. When the primary condition is not satisfied, the trajectory generator 118 returns to the process of step S100 and resets the target position TA. In this case, standby may occur until a timing at which the target position TA satisfying the primary condition can be set, or the target position TA may be set in front of the front reference vehicle mB or behind the rear reference vehicle mC and speed control for movement to the side of the target position TA may be performed.

As illustrated in FIG. 7, the trajectory generator 118, for example, projects the subject vehicle M onto a lane L2 that is a lane change destination and sets a prohibition area RA having slight front and rear margin distances. The prohibition area RA is set as an area extending from one end to the other end in a lateral direction of the lane L2.

In a case in which there are no nearby vehicles in the prohibition area RA, the trajectory generator 118 assumes, for example, an extension line FM and an extension line RM obtained by virtually extending a front end and a rear end of the subject vehicle M to the lane L2 that is the lane changes destination. The trajectory generator 118 calculates a collision margin time TTC(B) of the extension line FM and the front reference vehicle mB, and a rear reference vehicle TTC(C) of the extension line RM and the rear reference vehicle mC. The collision margin time TTC(B) is a time derived by dividing a distance between the extension line FM and the front reference vehicle mB by a relative speed of the subject vehicle M and the front reference vehicle mB. The collision margin time TTC(C) is a time derived by dividing a distance between the extension line RM and the rear reference vehicle mC by a relative speed of the subject vehicle M and the front reference vehicle mC. When the collision margin time TTC(B) is greater than a threshold value Th(B) and the collision margin time TTC(C) is greater than a threshold value Th(C), the trajectory generator 118 determines that the primary condition is satisfied. The threshold values Th(B) and Th(C) may be the same values or different values.

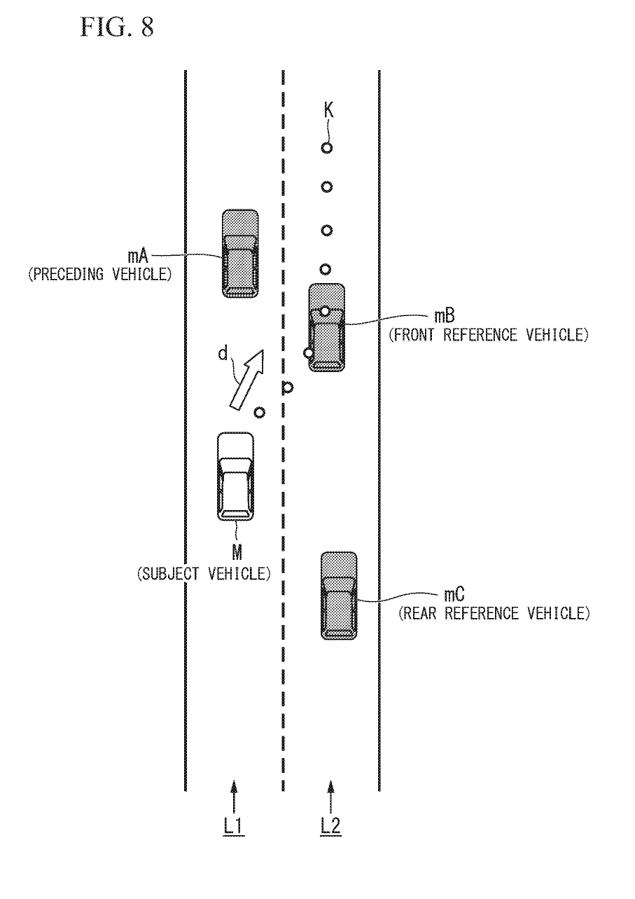

When the primary condition is satisfied, the trajectory generator 118 generates a trajectory for lane change (step S104). FIG. 8 is a diagram illustrating a state in which a trajectory for lane change is generated. For example, the trajectory generator 118 assumes that the preceding vehicle mA, the front reference vehicle mB, and the rear reference vehicle mC travel in a predetermined speed model, and generates a trajectory so that the subject vehicle M is located between the front reference vehicle mB and the rear reference vehicle mC at a certain future time without interfering with the preceding vehicle mA on the basis of the velocity model of the three vehicles and the speed of the subject vehicle M. For example, the trajectory generator 118 smoothly connects a current position of the subject vehicle M to a position of the front reference vehicle mB at a certain future time, a center of the lane that is a lane change destination, and an end point of the lane change using a polynomial curve such as a spline curve, and disposes a predetermined number of target positions K on this curve at equal intervals or unequal intervals. In this case, the trajectory generator 118 generates a trajectory so that at least one of the target positions K is disposed within the target position TA.

Then, the trajectory generator 118 determines whether or not a trajectory satisfying a setting condition can be generated (step S106). The setting condition is, for example, that an acceleration, a deceleration, a turning angle, an assumed yaw rate, or the like is within a predetermined range at each point of the trajectory point. When the trajectory satisfying the setting condition can be generated, the trajectory generator 118 outputs information on the trajectory for lane change to the travel controller 130 to cause the lane change to be performed (step S108). On the other hand, when the trajectory satisfying the setting condition cannot be generated, the trajectory generator 118 returns to the process of step S110. In this case, a process of entering a standby state or resetting the target position TA may be performed, as in a case in which the negative determination has been obtained in step S102.

The speed generator 120 operates when driving mode C is performed. The speed generator 120 generates a speed on the basis of the traveling aspect such as constant speed traveling, following traveling, and decelerating traveling.

### [Travel Control]

The travel controller 130 sets the driving mode to any one of the driving modes A to D under the control of the switching controller 140 and controls a control target including some or all of the travel driving force output device 90, the steering device 92, and the brake device 94 according to the set driving mode. It should be noted that the travel controller 130 may appropriately adjust a determined control amount on the basis of a detection result of the vehicle sensor 60.

When the driving mode A is performed, the travel controller 130 controls the travel driving force output device 90, the steering device 92, and the brake device 94 so that the subject vehicle M passes through the trajectory generated by the trajectory generator 118 at a scheduled time.

When driving mode B is performed, the travel controller 130 controls the steering device 92 so that the vehicle M travels along the trajectory generated by the trajectory generator 118.

When driving mode C is performed, the travel controller 130 controls the travel driving force output device 90 and the brake device 94 so that the vehicle M travels at the speed generated by the speed generator 120.

When driving mode D is performed, the travel controller 130, for example, outputs an operation detection signal input from the operation detection sensor 72 as it is to the travel driving force output device 90, the steering device 92, and the brake device 94.

### [Switching Control]

The switching controller 140 switches the driving mode on the basis of an operation for instructing acceleration, deceleration, or steering with respect to the operation device, in addition to switching between the driving modes on the basis of the driving mode designation signal input from the changeover switch 80. Further, the switching controller 140 switches from one of driving modes A, B, and C to driving mode D near the destination for the automated driving.

Hereinafter, switching of the driving mode based on the amount of operation with respect to the operation device will be described. In principle, when driving mode A is being performed, the switching controller 140 switches the driving mode to driving mode B when the amount of operation with respect to the accelerator pedal 70 or the brake pedal 72 (an accelerator opening degree or a brake depression amount) exceed each set threshold value.

Further, in a case in which driving mode A is being performed, the switching controller 140 switches the driving mode to driving mode C when the amount of operation with respect to the steering wheel 74 (for example, the amount of change in a steering angle, the steering angle itself, or a steering torque) exceeds a threshold value.

Further, in a case in which driving mode A is being performed, the switching controller 140 switches the driving mode to driving mode D when the amount of operation with respect to the accelerator pedal 70 or the brake pedal 72 exceeds each set threshold value and the amount of operation with respect to the steering wheel 74 exceeds the threshold value.

Further, in a case in which driving mode B is being performed, the switching controller 140 switches the driving mode to driving mode D when the amount of operation with respect to the steering wheel 74 exceeds the threshold value.

Further, when driving mode C is being performed, the switching controller 140 switches the driving mode to driving mode D when the amount of operation with respect to the accelerator pedal 70 or the brake pedal 72 exceeds a threshold value set for each of the accelerator pedal 70 and the brake pedal 72.

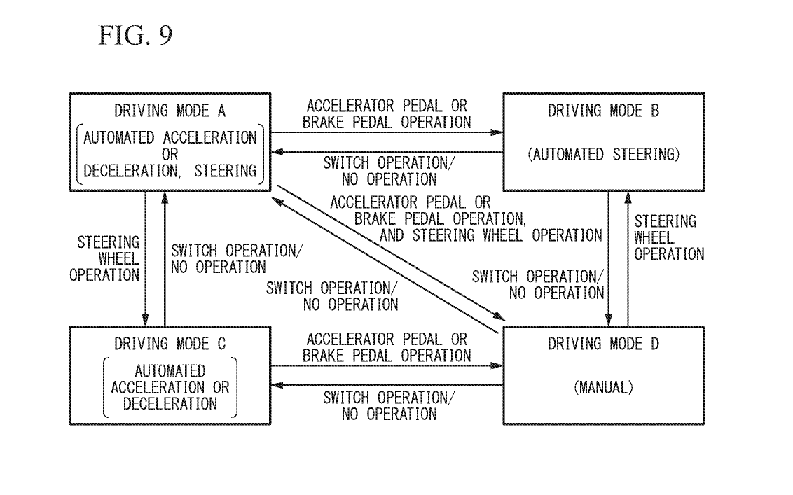

In a case in which the switching controller 140 switches the driving mode to a driving mode in which the degree of automated driving is high (a case in which the switching controller 140 switches the driving mode from driving mode D to another driving mode or driving mode B or driving mode C to driving mode A), the switching controller 140 performs the switching on the basis of the driving mode designation signal to be input from the changeover switch 80. Further, when there is no operation of the accelerator pedal 70 and the brake pedal 72 for a predetermined time after the driving mode is switched from driving mode A to driving mode B on the basis of the operation of the accelerator pedal 70, control such as returning to driving mode A may be performed (the same applies to combinations of other driving modes). FIG. 9 is a state transition diagram illustrating a change in the state of the switching controller 140 described above.

Here, when switching from driving mode A to driving mode B occurs, switching from the automatic control of the speed and the steering using the trajectory point to automatic control of only steering for traveling on the locus occurs. When this switching is performed in a scene in which fine control such as a lane change event is performed, the vehicle occupant can freely change the speed and, for example, a future speed assumed in the determination process described in step S106 in FIG. 6 becomes meaningless. Accordingly, continuity of the control cannot be maintained, and control is likely to be unstable.

Therefore, the switching controller 140 prohibits switching from driving mode A to driving mode B based on the amount of operation with respect to the accelerator pedal 70 while the lane change event is being performed. The lane change event here may include a branch event or a merging event or may not include the branch event or the merging event. It should be noted that the switching controller 140 performs switching from driving mode A to driving mode B based on the amount of operation with respect to the brake pedal 72 even while the lane change event is being performed. This is because an emergency brake operation based on an intention of the vehicle occupant is prioritized. Further, the switching controller 140 performs switching from driving mode A to driving mode C based on the amount of operation with respect to the steering wheel 74 even while the lane change event is being performed. This is because an avoidance action by the steering based on the intention of the vehicle occupant is prioritized.

Further, the switching controller 140 prohibits switching from driving mode A to driving mode D based on the amount of operation of the accelerator pedal 70 and the amount of operation of the steering wheel 74 while the lane change event is being performed. It should be note that the switching controller 140 performs switching from driving mode A to driving mode D based on the amount of operation with respect to the brake pedal 72 and the amount of operation of the steering wheel 74 even when the lane change event is being performed. Significance thereof is the same as above.

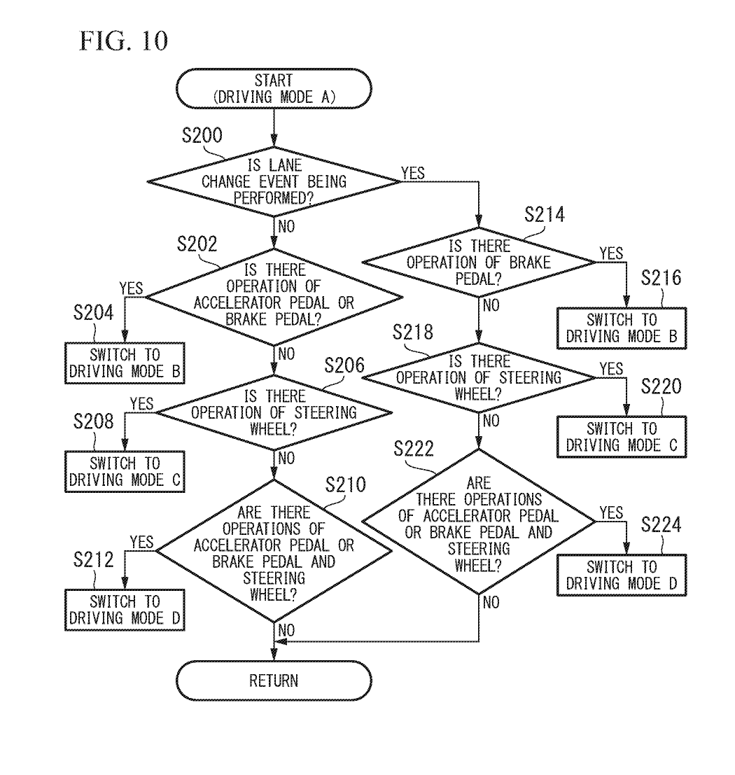

FIG. 10 is a diagram illustrating an example of a flow of a process that is executed by the switching controller 140. The process of this flowchart is repeatedly executed while driving mode A is being performed.

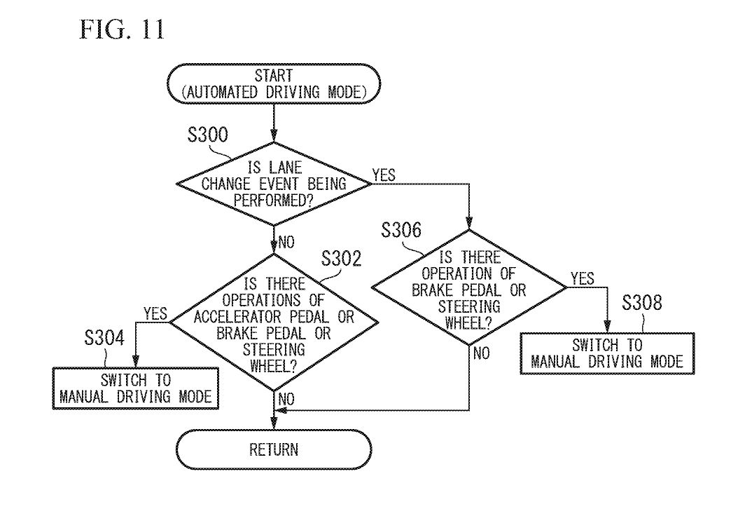

First, the switching controller 140 determines whether or not an event being performed is the lane change event (step S200). When the event being performed is not the lane change event, the switching controller 140 performs the processes of steps S202 to S212. The switching controller 140 determines whether or not the amount of operation of the accelerator pedal 70 or the brake pedal 72 exceeds a threshold value (step S202). It should be noted that, in FIG. 10, this is simply described as “there is an operation?” (The same applies to other steps in FIG. 10, and FIG. 11). When the amount of operation of the accelerator pedal 70 or the brake pedal exceeds the threshold value, the switching controller 140 switches the driving mode to driving mode B (step S204), and ends the process of this flowchart.

When a negative determination is obtained in step S202, the switching controller 140 determines whether or not the amount of operation of the steering wheel 74 exceeds a threshold value (step S206). When the amount of operation of the steering wheel 74 exceeds the threshold value, the switching controller 140 switches the driving mode to driving mode C (step S208) and ends the process of this flowchart.

When a negative determination is obtained in step S206, the switching controller 140 determines whether or not the amounts of the operations of the accelerator pedal 70, the brake pedal 72, and the steering wheel 74 exceed respective threshold values (step S210). When the amounts of the operations of the accelerator pedal 70, the brake pedal 72, and the steering wheel 74 exceed respective threshold values, the switching controller 140 switches the driving mode to driving mode D (step S212), and ends the process of this flowchart.

On the other hand, when the event being performed is the lane change event, the switching controller 140 performs the processes of steps S214 to S224. The switching controller 140 determines whether or not the amount of operation of the brake pedal 72 exceeds the threshold value (step S214). When the amount of operation of the brake pedal 72 exceeds the threshold value, the switching controller 140 switches the driving mode to driving mode B (step S216) and ends the process of this flowchart.

When a negative determination is obtained in step S214, the switching controller 140 determines whether or not the amount of operation of the steering wheel 74 exceeds the threshold value (step S218). When the amount of operation of the steering wheel 74 exceeds the threshold value, the switching controller 140 switches the driving mode to driving mode C (step S220) and ends the process of this flowchart.

When a negative determination is obtained in step S218, the switching controller 140 determines whether or not the amounts of the operations of the brake pedal 72 and the steering wheel 74 exceed the respective threshold values (step S222). When the amounts of the operations of the brake pedal 72 and the steering wheel 74 exceed the respective threshold values, the switching controller 140 switches the driving mode to driving mode D (step S224) and ends the process of this flowchart.

In the example of FIG. 10, while the lane change event is being performed, switching from driving mode A to driving mode D by operation of the accelerator pedal 70 or the brake pedal 72, and the steering wheel 74 is prohibited, but this may be permitted. That is, switching from driving mode A to driving mode B in a case in which only the accelerator pedal 70 is operated is prohibited, but switching from driving mode A to driving mode D in a case in which the steering wheel 74 is operated in addition to the accelerator pedal 70 may be permitted. In this case, the determination process of step S222 in FIG. 10 may be the same as the process of step S210.

In the first embodiment described above, driving mode C may not be performed, and only the driving modes A, B, and D may be performed. In this case, the processes of steps S206, S208, S218, and S220 in FIG. 10 are omitted.

Further, although switching of the driving mode based on the operation with respect to the operation device is restricted when the lane change event is executed in the first embodiment, switching between the driving modes based on the operation of the changeover switch 80 may be similarly restricted when the lane change event is executed.

According to the vehicle control device 100, the vehicle control method, and the vehicle control program in the first embodiment described above, the vehicle control device includes the automated driving control unit 110 that automatically controls at least a steering of the subject vehicle M so that the subject vehicle M travels along a route to a destination, and the switching controller 140 that switches the driving mode of the subject vehicle M among a plurality of driving modes including a first driving mode (driving mode A) and a second driving mode (driving mode B or driving mode C) in which a degree of automated driving is lower than that in the first driving mode on the basis of the operation performed with respect to the operation device (70, 72, and 74) on which the operation of the vehicle occupant is performed, the switching controller prohibiting switching from the first driving mode to the second driving mode based on the operation for instructing acceleration of the subject vehicle with respect to the operation device (for example, an operation with respect to the accelerator pedal 70) when the lane change event is performed by the automated driving control unit 110. Thus, it is possible to maintain the continuity of the control.

### SECOND EMBODIMENT

A second embodiment will be described below. In the first embodiment, the subject vehicle M switches the driving mode among driving modes A, B, C, and D, whereas in the second embodiment, the subject vehicle M switches the driving mode between automated driving mode and manual driving mode. The automated driving mode is a driving mode in which an acceleration or deceleration and steering of the subject vehicle M are automatically controlled and corresponds to driving mode A in the first embodiment. The manual driving mode is a driving mode in which the acceleration or deceleration of the subject vehicle M is controlled on the basis of an operation with respect to the accelerator pedal 70, the brake pedal 72, or the like, and steering is controlled on the basis of an operation with respect to the steering wheel 74 or the like, and corresponds to driving mode D in the first embodiment.

When the automated driving mode is being performed, the switching controller 140 in the second embodiment switches the driving mode to the manual driving mode when the amount of operation (an accelerator opening degree or a brake depression amount) with respect to the accelerator pedal 70 or the brake pedal 72 exceeds each set threshold value or when the amount of operation with respect to the steering wheel 74 (for example, the amount of change in the steering angle, the steering angle itself, or the steering torque) exceeds a threshold value.

When the driving mode is switched from the manual driving mode to the automated driving mode, the switching controller 140 in the second embodiment performs the switching, for example, on the basis of the driving mode designation signal input from the changeover switch 80. In addition, control such as returning to the automated driving mode may be performed when there is no operation of the accelerator pedal 70, the brake pedal 72, and the steering wheel 74 for a predetermined time after the driving mode is switched from the automated driving mode to the manual driving mode.

Further, the switching controller 140 in the second embodiment prohibits switching from the automated driving mode to the manual driving mode based on the amount of operation with respect to the accelerator pedal 70 while the lane change event is being performed. Accordingly, it is possible to maintain continuity of control, as in the first embodiment.

FIG. 11 is a diagram illustrating an example of a flow of a process that is executed by the switching controller 140 of the second embodiment. The process of this flowchart is repeatedly executed while the automated driving mode is being performed.

First, the switching controller 140 determines whether or not the event being performed is a lane change event (step S300). When the event being performed is not the lane change event, the switching controller 140 determines whether or not the amount of operation of the accelerator pedal 70, the brake pedal 72, or the steering wheel 74 exceeds a threshold value (step S302). When the amount of operation of the accelerator pedal 70, the brake pedal 72, or the steering wheel 74 exceeds the threshold value, the switching controller 140 switches the driving mode to the manual driving mode (step S304) and ends the process of this flowchart.

On the other hand, when the event being performed is the lane change event, the switching controller 140 determines whether or not the amount of operation of the brake pedal 72 or the steering wheel 74 exceeds the threshold value (step S306). When the amount of operation of the brake pedal 72 or the steering wheel 74 exceeds the threshold value, the switching controller 140 switches the driving mode to the manual driving mode (step S308) and ends the process of this flowchart.

According to the second embodiment described above, continuity of the control can be maintained, as in the first embodiment.

Although modes for carrying out the present invention have been described above using embodiments, the present invention is not limited to the embodiments at all, and various modifications and substitutions may be made without departing from the spirit of the present invention.

What is claim is:

1. A vehicle control device comprising:
an automated driving control unit that automatically controls at least a steering of a subject vehicle so that the subject vehicle travels along a route to a destination; and
a switching controller that switches a driving mode of the subject vehicle among a plurality of driving modes including a first driving mode and a second driving mode in which a degree of automated driving is lower than that in the first driving mode on the basis of an operation performed with respect to an operation device on which an operation of a vehicle occupant is performed, the switching controller prohibiting switching from the first driving mode to the second driving mode based on an operation for instructing acceleration of the subject vehicle with respect to the operation device when control to automatically perform lane change is performed by the automated driving control unit.

2. The vehicle control device according to claim 1,
wherein the first driving mode is a driving mode in which both acceleration or deceleration and a steering of the subject vehicle are automatically controlled, and
the second driving mode is a driving mode in which the steering of the subject vehicle is automatically controlled and the acceleration or deceleration is controlled on the basis of an operation with respect to the operation device.

3. The vehicle control device according to claim 1,
wherein the first driving mode is a driving mode in which both acceleration or deceleration and a steering of the subject vehicle are automatically controlled, and
the second driving mode is a driving mode in which both the acceleration or deceleration and the steering of the subject vehicle are controlled on the basis of an operation of the vehicle occupant with respect to the operation device.

4. The vehicle control device according to claim 1,
wherein when control to automatically perform the lane change is not performed by the automated driving control unit, the switching controller switches the driving mode of the subject vehicle from the first driving mode to the second driving mode on the basis of the operation for instructing acceleration of the subject vehicle with respect to the operation device.

5. The vehicle control device according to claim 1,
wherein when the automated driving control unit performs the control to automatically perform the lane change, the switching controller does not prohibit switching from the first driving mode to the second driving mode based on an operation for instructing deceleration of the subject vehicle with respect to the operation device.

6. A vehicle control method comprising:
automatically controlling, by an in-vehicle computer, at least a steering of a subject vehicle so that the subject vehicle travels along a route to a destination; and
switching, by the in-vehicle computer, a driving mode of the subject vehicle among a plurality of driving modes including a first driving mode and a second driving mode in which a degree of automated driving is lower than that in the first driving mode on the basis of an operation performed with respect to an operation device on which an operation of a vehicle occupant is performed, and prohibiting switching from the first driving mode to the second driving mode based on an operation for instructing acceleration of the subject vehicle with respect to the operation device when control to automatically perform lane change is performed by automatically controlling at least the steering of the subject vehicle.

7. A non-transitory computer-readable storage medium storing a program causing an in-vehicle computer to:
automatically control at least a steering of a subject vehicle so that the subject vehicle travels along a route to a destination;
switch a driving mode of the subject vehicle among a plurality of driving modes including a first driving mode and a second driving mode in which a degree of automated driving is lower than that in the first driving mode on the basis of an operation performed with respect to an operation device on which an operation of a vehicle occupant is performed; and
prohibit switching from the first driving mode to the second driving mode based on an operation for instructing acceleration of the subject vehicle with respect to the operation device when control to automatically perform lane change is performed by automatically controlling at least the steering of the subject vehicle.
